(19) United States
(12) Patent Application Publication
(10) Pub. No.: US 2001/0048894 A1
(43) Pub. Date: Dec. 6, 2001

(54) Vial handling system with improved vial gripper

(76) Inventors: Harry W. Schmidt, Fairfield, OH (US); David M. Neal, Hamilton, OH (US)

Correspondence Address: Christopher R. Christenson, WESTMAN, CHAMPLIN & KELLY, P.A., International Center - Suite 1600, 900 Second Avenue South, Minneapolis, MN, 55402-3319, US

(21) Appl. No.: 09/803,721

(22) Filed: Mar. 9, 2001

Related U.S. Application Data
(60) Provisional application No. 60/188,665, filed on Mar. 11, 2000.
(60) Provisional application No. 60/188,269, filed on Mar. 10, 2000.

(51) Int. Cl. B01L 3/02

(52) U.S. Cl. 422/63; 422/100; 422/99

(57) ABSTRACT

A vial autosampler includes a gripper mechanism having an actuator, a first jaw, and a second jaw. The first and second jaws are coupled to the actuator. At least one of the first and second jaws includes a magnet disposed therein. Upon energization of the actuator, the first and second jaws are urged in a first direction which energization opposes the magnetic urging of the magnets.

### CROSS REFERENCE TO RELATED APPLICATIONS

This application claims the priority of earlier filed co-pending provisional patent application Nos. 60/188,665, filed Mar. 11, 2000 and entitled IMPROVED VIAL HANDLING SYSTEM; and 60/188,269 filed Mar. 10, 2000 and entitled WATER AND SOIL AUTOSAMPLER.

### BACKGROUND OF THE INVENTION

The present invention relates to vial autosamplers of the type used for laboratory automation. More specifically, the present invention relates to vial handling within the vial autosampler.

Vial autosamplers are used to automate laboratory analysis associated with gas chromatography, carbon measurement (total carbon and total organic carbon) as well as other types of analyses. Typically, a vial autosampler has a storage area adapted to hold a number of vials to be analyzed. A robotic system of some sort, such as a robotic arm, generally grasps the vials from the storage area and transports them to an analytical site. Once transported to the analytical site, the vial contents are sampled and the appropriate analysis is performed.

With the advent of laboratory automation, efficiencies have been greatly improved. One of the main reasons for such efficiency is the automatic nature of such machines which is provided by their various robotic systems. Such robotic systems are not without their own costs however. While efficiency may be increased by use of robotics, the cost of a given laboratory automation machine, such as a vial autosampler is almost always increased. Therefore, the provision simplification of robotic complexity work also reduces system complexity as well.

In the design of automated vial handling systems, vial gripper design is very important. The contents of a given vial may represent significant analytical effort, and if a vial is mishandled, the efforts may be lost. It is important that the vial be gripped with sufficient force to ensure that it will not drop during transport and delicately enough such that damage to the vial does not occur. Moreover, it is important that in the event of power failure, the gripper does not suddenly open and allow the vial to drop.

Another technical challenge is due to automatic vial autosamplers that store a number of vials in a rectangular matrix. Thus, a gripper must be able to effectively select and transport any given vial, even though the vials may be disposed relatively closely together.

### SUMMARY OF THE INVENTION

A vial autosampler includes a gripper mechanism having an actuator, a first jaw, and a second jaw. The first and second jaws are coupled to the actuator. At least one of the first and second jaws includes a magnet disposed therein. Upon energization of the actuator, a first and second jaws are urged in a first direction which energization opposes the magnetic urging of the magnets.

### BRIEF DESCRIPTION OF THE DRAWINGS

FIG. 1 is a perspective view of an illustrative automatic vial handling system with which embodiments of the present invention are useful.

FIGS. 2A and 2B are top plan and side elevation views, respectively, of a gripper mechanism in accordance with an embodiment of the present invention.

### DETAILED DESCRIPTION OF THE PREFERRED EMBODIMENTS

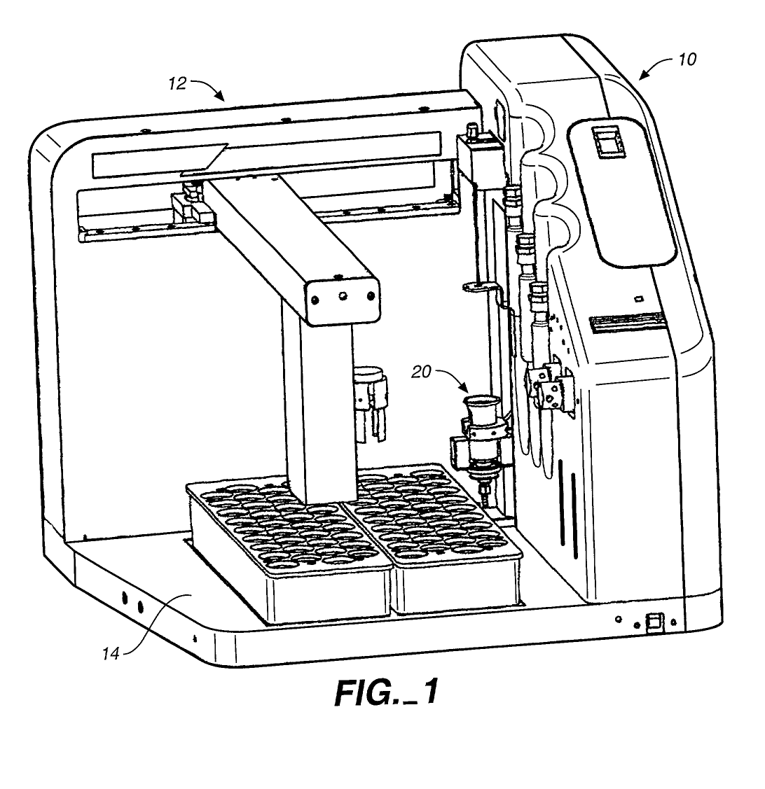

FIG. 1 shows a perspective view of a vial autosampler device 10 in accordance with the invention. The device 10 includes a base unit 12 that includes a vial storage platform area 14, a sampling station 20, and a fluid handling system comprising valves, glasswork, an other fluid handling components. Sampling station 20 receives a vial containing a specimen and extracts a fluid from the vial for further analysis. Finally, device 10 includes a central programmable control circuit that accepts user inputs and controls the operation of device 10.

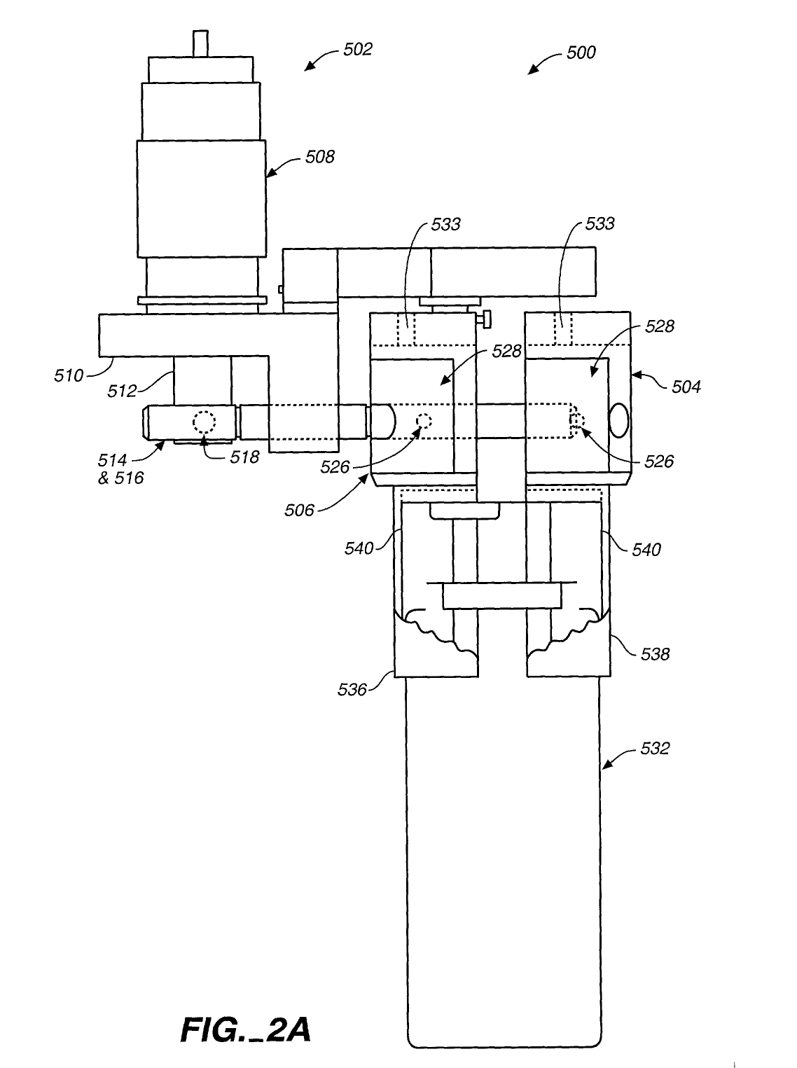

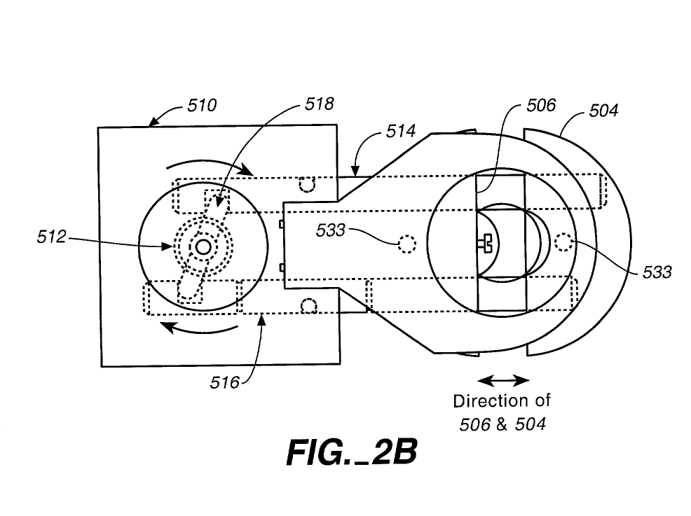

FIGS. 2A and 2B are top plan and side elevation views, respectively, of an improved gripper mechanism for use with a vial autosampler. The gripper mechanism illustrated in FIGS. 2A and 2B is preferably mounted upon a robotic arm that is adapted to transport vials from vial storage area 14 to the vial analysis site(s).

Gripper mechanism 500 includes actuator 502 and jaws 504 and 506. Although gripper mechanism 500 will be described with respect to two jaws, it is contemplated that more than two jaws could be used. It is preferred that jaws 504 and 506 are constructed from a lightweight non-magnetic material. Suitable examples of such material include aluminum and plastic. Although actuator 502 will be described with respect to a specific actuator embodiment, it is to be understood that actuator 502 can be any device capable of moving jaws 504 and 506 with respect to each other. Thus, actuator 502 can be an electric solenoid, an air cylinder, or any other suitable device. As shown, however, actuator 502 includes a rotary DC motor 508 that preferably operates on 24 volts DC. Motor 508 is preferably mounted to mounting block 510 such that shaft 512 passes through block 510 and is adapted to rotate with respect thereto. Shaft 512 is coupled to drive rods 514, 516 by pin 518. Pin 518 contacts drive rods 514, 516 such that rotation of pin 518, as indicated by arrows 520, translates drive rods 514 and 516 in the directions of arrows 522 and 524, respectively. Since drive rod 514 is coupled to jaw 506, and drive rod 516 is coupled to jaw 504, rotation of pin 518 causes jaws 504 and 506 to be separated from one another. Translation of both jaws in opposite directions is important to ensure that the center point of a vial either being picked up or put down is not changed thus not causing a lateral displacement of the vial.

As can be seen in FIGS. 2A and 2B, jaws 504, 506 are preferably coupled to drive rods 514, 516, respectively, by pins 526. However, it should be understood that one aspect of the invention is the ability to change jaws. Thus, embodiments where jaws 504 and 506 can be decoupled from drive rods 514, 516 are contemplated. With such interchangeable jaw embodiments, different jaws can be selected for particular vial applications. One set of jaws may be adapted to grasp smaller vials while another set is adapted for grasping larger vials. Further, jaws with different internal surface features (which features will be described later) can be selected such that one set of jaws can be adapted to apply higher force and thus lift heavier vials, while another set of jaws can be adapted to apply less pressure and thus lift more fragile vials.

At least one of jaws 504 and 506 includes a magnet that is disposed in such a manner to assist with the gripping function. In the illustrated embodiment, jaws 504 and 506 include magnets 528 and 530, respectively. Magnets 528 are preferably fixed within jaws 504 and 506 by set screws 533. Although two magnets 528 are shown, it is expressly contemplated that embodiments can be practiced using a single magnet, as well as more than two magnets. In a single magnet embodiment, it is important to ensure that the jaw opposite the jaw with the magnet be constructed from a material that interacts with magnetic fields, such as suitable metals. Preferably, magnets 528 are powerful rare earth magnets. In the illustrated embodiment, magnets 528 are oriented with respect to one another such that opposite poles of the magnets are facing one another thereby causing magnets 528 to urge jaws 504 and 506 together. Thus, when motor 508 is energized, drive rods 514, 516 overpower the magnetic urging of magnets 528 to thereby open jaws 504 and 506 to grasp a vial. To close jaws 504 and 506, motor 508 is simply de-energized, thus allowing the magnetic forces between magnets 528 to once again urge jaws 504 and 506 together closing the gripper mechanism 500 upon vial 532 (partially illustrated in FIG. 1B).

Since autosampler power loss will simply de-energize motor 508 and cause magnets 528 to grip, the system can be considered fail-safe since it ensures that vial 532 is not dropped upon power loss. However, if such a fail-safe operation is not desired, it is contemplated that the orientation of magnets 528 can be changed such that they repel one another, in which case motor 508 can be reversed such that its energization will cause jaws 504 and 506 to clench together. Using magnets 528 simplifies robotic gripper control since a single energization signal having an on-condition and an off-condition can effect opening and closing jaws 504 and 506. Further, by using magnets 528 to assist gripping provides a simpler gripper mechanism than systems which use springs. Further, the ability of magnets 528 to urge jaws 504 and 506 together without a mechanical coupling between jaws 504 and 506, unlike a tension spring, facilitates changing to different sets of jaws since it is unnecessary to couple any sort of mechanical element, such as spring, between jaws 504 and 506.

Jaws 504 and 506 include lower portions 536 and 538, respectively. Lower portions 536 and 538 are adapted to contact the vial and assert sufficient frictional force to prevent the vial from slipping from gripper mechanism 500 as the vial is lifted. Preferably, each lower portion is shaped semicircularly such that the lower portions envelop substantially all of the vial outer diameter. However, it is expressly contemplated that embodiments providing a number of fingers could also be used. Lower portions 536 and 538 have friction portions 540. Friction portions 540 are formed of an incompressible or semi-compressible material which generates a relatively high level of friction with vial 532. One example of such material is commercially available anti-slip materials, such as diamond friction tape available from McMaster-Carr Supply Company, of Chicago Ill. under catalog number 6244T11. Those skilled in the art will recognize that a number of other materials can be used for portions 540 and such embodiments are expressly contemplated. For example, it is believed that silicone rubber or urethane could be used in friction portions 540.

Although the present invention has been described with reference to preferred embodiments, workers skilled in the art will recognize that changes may be made in form and detail without departing from the spirit and scope of the invention.

What is claimed is:

1. In a vial autosampler, a gripper mechanism comprising:
an actuator;
a plurality of jaws coupled to the actuator; and
wherein the actuator urges a first jaw of the plurality of jaws and a second jaw of the plurality of jaws in a first direction upon energization, and wherein at least one of the jaws includes a magnet disposed therein, which magnet urges the plurality of jaws in a second direction opposite the urging of the actuator.

2. The gripper mechanism of claim 1 wherein both first and second jaws include at least one magnet disposed within each jaw.

3. The gripper mechanism of claim 2 wherein the actuator urges the first and second jaws in the first direction to close upon energization.

4. The gripper mechanism of claim 2 wherein the actuator urges the first and second jaws in the first direction to open upon energization.

5. The gripper mechanism of claim 1 wherein the plurality of jaws are formed of a non-magnetic material.

6. The gripper mechanism of claim 1 wherein the actuator is an air cylinder.

7. The gripper mechanism of claim 1 wherein the actuator is an electric solenoid.

8. The gripper mechanism of claim 1 wherein the actuator is a rotary motor.

9. The gripper mechanism of claim 8 wherein the rotary motor is a DC motor.

10. The gripper mechanism of claim 8, and further comprising at least one drive rod coupling the motor to at least one jaw.

11. The gripper mechanism of claim 8, and further comprising a pair of drive rods coupling the motor to the plurality of jaws.

12. The gripper mechanism of claim 1 wherein the plurality of jaws are exchangeable.

13. The gripper mechanism of claim 1 wherein the at least one magnet is a rare-earth magnet.

14. The gripper mechanism of claim 1 wherein each jaw includes a lower portion having a friction portion that contacts a vial.

15. The gripper mechanism of claim 14 wherein the friction portion of at least one jaw is formed of a compressible material.

16. The gripper mechanism of claim 15 wherein the compressible material is an urethane.

17. The gripper mechanism of claim 14 wherein the friction portion of at least one jaw is formed of an incompressible material.

18. The gripper mechanism of claim 17 wherein the incompressible material in diamond friction tape.

19. An autosampler comprising:
a vial storage area adapted to store a number of vials for sampling;
a vial analysis station adapted to extract a sample from a given vial;
a vial gripper mechanism adapted to select and transport the given vial from the storage area to the vial analysis station, wherein the gripper mechanism includes:
an actuator;
a gripper member coupled to the actuator wherein the gripper member includes a first jaw and a second jaw;
wherein the actuator urges the first jaw and the second jaw in a first direction upon energization; and
wherein at least one of the jaws includes a magnet disposed therein, which magnet urges the jaws in a second direction opposite the urging of the actuator.

20. The autosampler of claim 19, wherein upon energization, the actuator urges the jaws of the gripper member toward each other.
